(19) United States
(12) Patent Application Publication
(10) Pub. No.: US 2025/0293777 A1
(43) Pub. Date: Sep. 18, 2025

(54) Information Communications using Modulated Waves Applied to an Optical Fiber

(71) Applicant: The Boeing Company, Arlington, VA (US)

(72) Inventor: Nathan D. Hiller, Irvine, CA (US)

(21) Appl. No.: 18/591,232

(22) Filed: Feb. 29, 2024

Related U.S. Application Data
(60) Provisional application No. 63/581,060, filed on Sep. 7, 2023.

(51) Int. Cl. H04B 10/2507; H04B 10/80

(52) U.S. Cl. CPC H04B 10/2507; H04B 10/80

(57) ABSTRACT

A communications system comprising an acoustic transmitter and a controller. The controller is in communication with acoustic transmitter. The controller is configured to transmit the hydroacoustic waves at an underwater cable having an optical fiber in which light travels using the acoustic transmitter. The hydroacoustic waves impinge on the underwater cable causing localized changes in the underwater cable that changes a state of the light traveling in the underwater cable to correspond to information encoded in the hydroacoustic waves.

### CROSS-REFERENCE TO RELATED APPLICATION

This application claims the benefit of U.S. Provisional Patent Application Ser. No. 63/581,060, filed Sep. 7, 2023, and entitled “Information Communications using Modulated Waves Applied to an Optical Fiber,” which is incorporated herein by reference in its entirety.

### BACKGROUND INFORMATION

### 1. Field

The present disclosure relates generally to communications and in particular, to communications using modulated waves applied to an optical fiber in an underwater cable.

### 2. Background

Underwater vehicles use communication techniques that are different from those used in above water environments. Radio frequency signals are not commonly used because of the rapid attenuation in water. Although low frequency radio waves have low attenuation in water, their data rate is limited by bandwidth in the Shannon capacity theorem. As a result, radio frequency transmissions are not feasible or practical for transmitting moderate to high data rates over long distance.

Sound is a type of transmission used for underwater communications. Information can be encoded that is transmitted as acoustic waves underwater. These types of acoustic waves are also referred to as hydroacoustic waves.

Some types of transmission systems using sound waves may have short operational ranges, relatively low bandwidth capacity, require large amounts of power, and are not secure given the broad beam divergence caused by wave diffraction. For example, sonar and other sound-based communication techniques may suffer from relatively low bandwidth capacity.

To avoid issues with signal attenuation in free-space (e.g., using water as a communication medium) a tether that includes a communication medium such as wires or optical fiber can be used. The tether may connect an underwater vehicle to a receiving system. The communication medium may reduce signal attenuation; however, the tether may limit range and mobility of the underwater vehicle.

Therefore, it would be desirable to have a method and apparatus that take into account at least some of the issues discussed above, as well as other possible issues. For example, it would be desirable to have a method and apparatus that overcome a technical problem with current techniques for communications using hydro acoustic signals.

### SUMMARY

An embodiment of the present disclosure provides a communications system. The communications system comprises an acoustic transmitter and a controller. The controller is in communication with acoustic transmitter. The controller is configured to transmit the hydroacoustic waves at an underwater cable having an optical fiber in which light travels using the acoustic transmitter. The hydroacoustic waves impinge on the underwater cable causing localized changes in the underwater cable that changes a state of the light traveling in the underwater cable to correspond to information encoded in the hydroacoustic waves.

Another embodiment of the present disclosure provides a communications system for an underwater vehicle utilizing an underwater cable having an optical fiber in which light travel. The communications system comprises an acoustic transmitter configured to emit hydroacoustic waves having a frequency corresponding to a resonance frequency of the underwater cable having the optical fiber to optimize transfer of the hydroacoustic waves impinging the underwater cable that causes changes to the optical fiber that modify the light traveling in the optical fiber. The acoustic transmitter is configured to transmit the hydroacoustic waves through water at an angle relative to the underwater cable such that first extremas the hydroacoustic waves matches second extremas in the changes of the underwater cable at its resonance frequency.

Still another embodiment of the present disclosure provides a method for transmitting information. The information is encoded in hydroacoustic waves. The hydroacoustic waves are transmitted at an underwater cable having an optical fiber in which light travel. The hydroacoustic waves impinge on the underwater cable causing localized changes in the underwater cable that changes a state of the light traveling in the underwater cable to correspond to information encoded in the hydroacoustic waves.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of a schematic diagram of a communication system providing communications using modulated waves applied to an optical fiber in an underwater cable in accordance with an illustrative embodiment;

FIG. 1A is an illustration of a transverse wave in accordance with an illustrative embodiment;

FIG. 1B is an illustration of a longitudinal wave in accordance with an illustrative embodiment;

FIG. 2 is an illustration of a block diagram of a communications environment in accordance with an illustrative embodiment;

FIG. 3 is an illustration of a schematic diagram for transmitting information in accordance with an illustrative embodiment;

FIG. 4 is an illustration of transmission angles in accordance with an illustrative embodiment;

FIG. 5 is an illustration of a communication system for transmitting information in accordance with an illustrative embodiment;

FIG. 6 is an illustration of a flowchart of a process for transmitting information in accordance with an illustrative embodiment;

FIG. 7 is an illustration of a flowchart of a process for transmitting hydroacoustic waves in accordance with an illustrative embodiment;

FIG. 8 is an illustration of a flowchart of a process for transmitting hydroacoustic waves in accordance with an illustrative embodiment;

FIG. 9 is an illustration of a flowchart of a process for transmitting hydroacoustic waves in accordance with an illustrative embodiment;

FIG. 10 is an illustration of a flowchart of a process for recovering information in accordance with an illustrative embodiment;

FIG. 11 is an illustration of a flowchart of process for identifying information in accordance with an illustrative embodiment;

FIG. 12 is an illustration of a schematic diagram of a physical change detection system that detects a physical change to an underwater cable that carries information in an optical fiber in accordance with an illustrative embodiment;

FIG. 13 is an illustration of a block diagram of a physical change detection environment in accordance with an illustrative embodiment;

FIG. 14 is an illustration of a response graph for an underwater cable in accordance with an illustrative embodiment;

FIG. 15 is an illustration of a graph of a resonant frequency for a cable in accordance with an illustrative embodiment;

FIG. 16 is an illustration of a flowchart of a process for predicting a physical change in an underwater cable in accordance with an illustrative embodiment; and

FIG. 17 is a flowchart of a process for detecting a response to hydroacoustic waves impinging upon an underwater cable in accordance with an illustrative embodiment.

### DETAILED DESCRIPTION

The illustrative embodiments recognize and take into account one or more different considerations as described herein. One solution involves using a communications system that takes into account the presence of existing infrastructure such as optical fibers in underwater cables. An undersea optical fiber in an underwater cable can be disturbed using vibrations from hydroacoustic waves that are applied to the underwater cable.

For example, one technique involves applying light pulses to an optical fiber and receiving backscattered light at a phase sensitive optical time domain reflectometry (OTDR) device. The backscattered light includes portions of the applied light pulses that are backscattered (i.e., Rayleigh backscatter) by randomly distributed small variations in the refractive index in the optical fiber. This technique includes determining a difference between the backscattered light and a backscatter pattern associated with the optical fiber. Further, the technique can include determining a communication signal encoded in the backscattered light based on the difference, where the communication signal is encoded in the backscattered light responsive to hydroacoustic waves applied to the optical fiber at a location remote from the phase-sensitive OTDR device. Another technique involves applying

hydroacoustic waves to the underwater cable. The hydroacoustic waves impinge on the underwater cable causing a localized disturbance such as a physical wave in the underwater cable. This physical wave changes the state of light traveling in the cable. The application of hydroacoustic waves to generate the physical wave can be such that the light traveling in the optical fiber in the underwater cable corresponds to information encoded in the hydroacoustic waves. This correspondence enables identifying the information encoded in the hydroacoustic waves using the changes to the state of the light. The physical wave can be, for example, a transverse wave or a longitudinal wave.

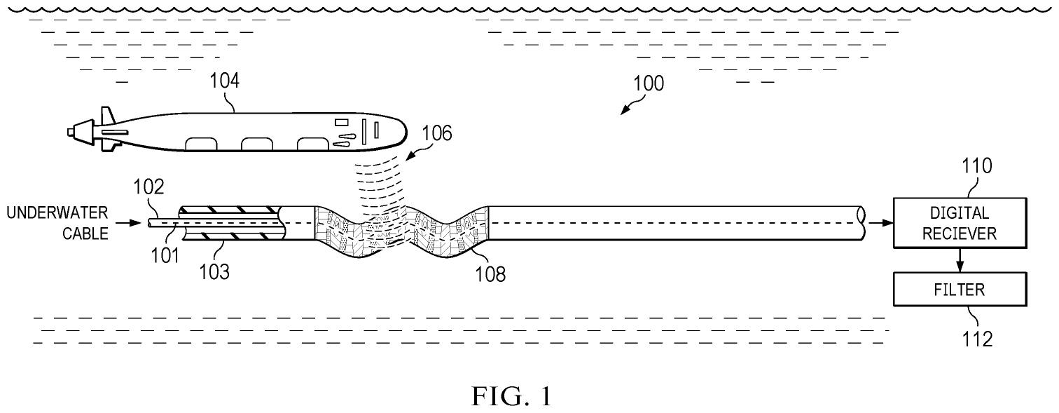

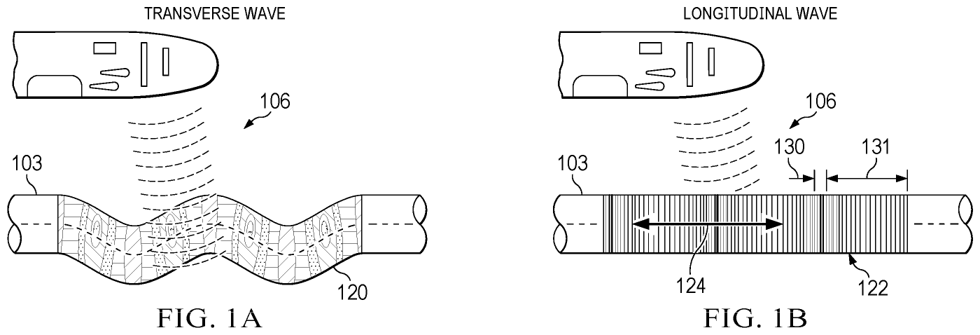

With reference now to the figures and, in particular, with reference to FIG. 1, an illustration of a schematic diagram of a communication system providing communications using modulated waves applied to an optical fiber in an underwater cable is depicted in accordance with an illustrative embodiment. In communications environment 100, light 101 travels through optical fiber 102 in underwater cable 103. In this example, light 101 can travel in one or more optical communications channels within optical fiber 102. Light 101 can be modulated to encode or carry information. For example, different characteristics of light 101 can be modulated. These characteristics can include at least one of amplitude, frequency, phase modulation, pulse width, pulse position, pulse amplitude, and other characteristics.

As depicted, unmanned underwater vehicle (UUV) 104 can transmit hydroacoustic waves 106 that impinges on underwater cable 103. In this example, hydroacoustic waves 106 are emitted at a hydroacoustic frequency that is a resonance frequency of underwater cable 103.

In this example, hydroacoustic waves 106 impinging on underwater cable 103 causes localized changes 108 to occur in underwater cable 103 including optical fiber 102.

Localized changes 108 are short-term changes in these examples. Localized changes 108 can be a deformation of optical fiber 102 in the form of a vibrational response that has a frequency. Further, these localized changes of optical fiber 102 can change the optical properties of optical fiber 102 at the location of localized changes 108.

For example, when optical fiber 102 is vibrated, the asymmetry of the vibration can create asymmetric stress in optical fiber 102, resulting in a polarization dependent effective refractive index in the fiber bends due to the stress-optic effect (i.e., birefringence). In another example, when optical fiber 102 is vibrated, the asymmetry of the vibration can create polarization dependent optical path lengths in the region where optical fiber 102 bends. This bending of optical fiber 102 can change the polarization of light 101 depending on the polarization state of light 101 relative to the polarization dependent optical path lengths. In addition, both the birefringence and optical path length differences described in these two examples can occur simultaneously.

Localized changes 108 can take a number of different forms. As used herein, a “number of” when used with referenced items means one or more items. For example, a number of forms can be one or more forms.

In this example, localized changes 108 can be a physical wave in the form of a transverse wave in this figure. This transverse wave can be, for example, one of a moving transverse wave and a stationary traverse wave.

As a result, localized changes 108 can change the state of light 101 traveling through optical fiber 102. This change in state can be at least one of polarization, phase, or some other state of light 101.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

In other words, energy in hydroacoustic waves 106 can be imprinted on a characteristic such as a state of polarization (SOP) of light 101. This polarization change can occur in each of the optical channels that light 101 travels in optical fiber 102.

In this illustrative example, these changes to the state of light 101 can be detected by a receiver such as digital receiver 110. Digital coherent receiver 110 is a hardware device optically connected to optical fiber 102. This type of device is an optical device that can detect and decode phase, polarization, amplitude, and other information from modulated optical signals such as light 101. This device converts light 101 into electrical signals.

With a greater number of optical channels, there is increased sensitivity in digital coherent receiver 110 detecting changes in the state of light 101. As a result, information can be transferred at a higher bit rate. Alternatively, in an application where power may be limited, for the same data rate, less power can be used to transmit the hydroacoustic wave. In addition, a combination of higher data rates and lower transmit power can be implemented.

These changes can be associated with changes such as waves, bumps, earthquakes, or other phenomena. Each of these types of changes can have a characteristic frequency. In these examples, known or expected changes are filtered out using filter 112 resulting in recovering the information that is encoded in the hydroacoustic waves 106 that encodes information. In this example, filter 112 can isolate changes having a frequency at or near the frequency of hydroacoustic waves 106, which is the resonance frequency of underwater cable 103 in this example.

For example, state of polarization changes in light 101 can occur in response to the energy from hydroacoustic waves 106. In one illustrative example, when a greater number of optical channels are present, the output of the digital coherent receiver for each of these channels can be combined to improve the signal to noise ratio (SNR) of the hydroacoustic wave. This combining of channels may improve the signal to noise ratio in proportion to the square root of the number of optical channels. For example, with 100 optical channels, the signal to noise ratio may be improved by 10 dB.

FIG. 1 is intended as an example, and not as an architectural limitation for the different illustrative embodiments. For example, digital coherent receiver 110 is shown as receiving light 101 at an end of optical fiber 102 in underwater cable 103. Further, although hydroacoustic waves 106 is emitted using the resonance frequency of underwater cable 103, other frequencies can be used in other illustrative examples of the resonance frequency.

FIGS. 1A and 1B illustrate different types of physical waves that can be generated in response to hydroacoustic waves 106 transmitted from unmanned underwater vehicle 104. In the illustrative examples, the same reference numeral may be used in more than one figure. This reuse of a reference numeral in different figures represents the same element in the different figures.

FIG. 1A is an illustration of a transverse wave in accordance with an illustrative embodiment. In this illustrative example, unmanned underwater vehicle 104 transmits hydroacoustic waves 106 that impinges on underwater cable 103. This impingement on underwater cable 103 causes a physical wave in the form of transverse wave 120. In this example, transverse wave 120 is a wave in which oscillations or vibrations occur perpendicular to the direction of energy transfer from hydroacoustic waves 106.

FIG. 1B is an illustration of a longitudinal wave in accordance with an illustrative embodiment. In this depicted example, unmanned underwater vehicle 104 transmits hydroacoustic waves 106 that impinges on underwater cable 103. These hydroacoustic waves impinging on underwater cable 103 causes a physical wave in the form of longitudinal wave 122. One or both of these types of waves can be generated in response to hydroacoustic waves 106 impinging on underwater cable 103. In this example, longitudinal wave 122 is a wave with material density variations that propagate over time and space. In this example, the density variations occur in the direction of axis 124. In this example, the density of components in underwater cable 103 in section 130 are denser than the density of underwater cable 103 in section 131. Section 130 is an example of a density amplitude extreme, which is also referred to as a density extreme. These higher density areas from longitudinal wave 122 represent compression of underwater cable 103. This compression can be for components in underwater cable 103. The lower density areas represent stretching of underwater cable 103.

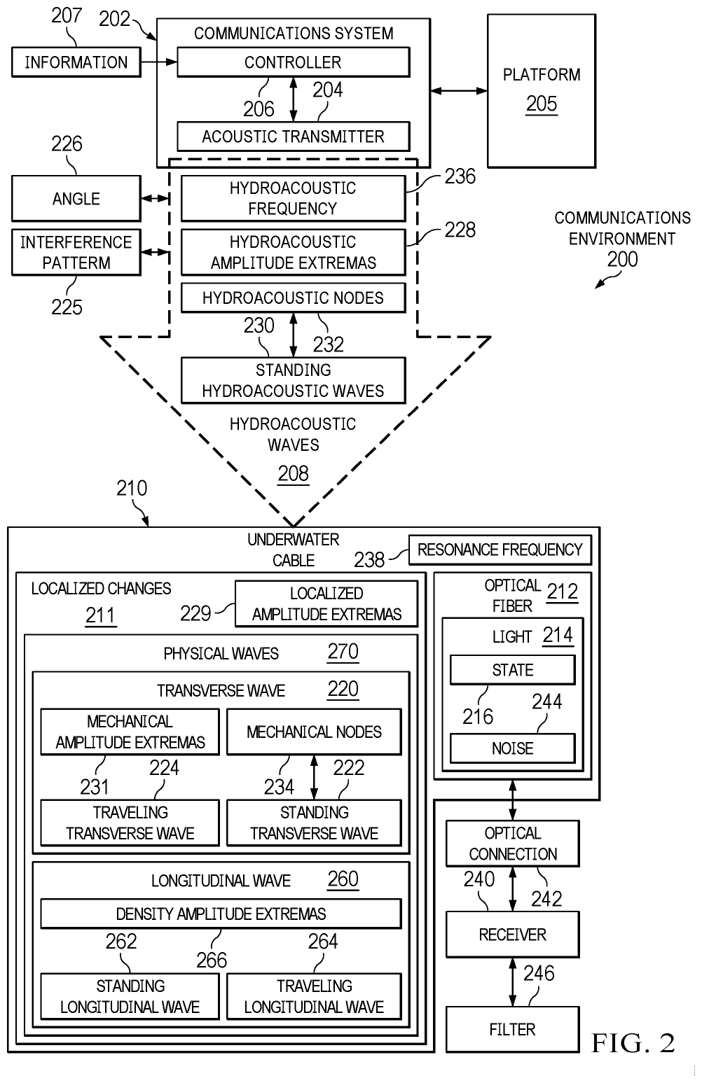

With reference now to FIG. 2, an illustration of a block diagram of a communications environment is depicted in accordance with an illustrative embodiment. In this illustrative example, communications environment 100 in FIG. 1 is an example of an implementation for communications environment 200 in FIG. 2.

Communications system 202 can be implemented in platform 205. In this example, platform 205 can be selected from at least one of a stationary platform, a mobile platform, an aquatic-based structure, an unmanned underwater vehicle, a submarine, an underwater habitat, an underwater sensor station, an undersea lab, a surface ship, or other suitable platform.

In this example, communications system 202 includes a number of different components that can be used to transmit information. As depicted, communications system 202 comprises acoustic transmitter 204 and controller 206.

In this example, acoustic transmitter 204 is a hardware system that can also include software and is connected to platform 205. Acoustic transmitter 204 is connected to platform 205 and is configured to transmit hydroacoustic waves 208.

When one component is “connected” to another component, the connection is a physical connection in these examples. For example, a first component, acoustic transmitter 204, can be considered to be physically connected to a second component, platform 205, by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

The operation of acoustic transmitter 204 is controlled by controller 206. Controller 206 can be implemented in software, hardware, firmware, or a combination thereof. When software is used, the operations performed by controller 206 can be implemented in program instructions configured to run on hardware, such as a processor unit. When firmware is used, the operations performed by controller 206 can be implemented in program instructions and data can be stored in persistent memory to run on a processor unit. When hardware is employed, the hardware can include circuits that operate to perform the operations in controller 206.

In the illustrative examples, the hardware can take a form selected from at least one of a circuit system, an integrated circuit, an application specific integrated circuit (ASIC), a programmable logic device, and a processor unit. When controller 206 is a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

When controller 206 includes a number of processor units, the number of processor units can be selected from at least one of a single core processor, a dual-core processor, a multi-processor core, a general-purpose central processing unit (CPU), a graphics processing unit (GPU), a digital signal processor (DSP), or some other suitable type of hardware configured to perform a number of operations.

Additionally, the processes can be implemented in organic components integrated with inorganic components and can be comprised entirely of organic components excluding a human being. For example, the processes can be implemented as circuits in organic semiconductors.

In one illustrative example, controller 206 is capable of executing program instructions implementing processes in the illustrative examples. In other words, the program instructions can be computer-readable program instructions.

In this illustrative example, controller 206 controls the operation of acoustic transmitter 204. In one illustrative example, controller 206 identifies information 207 that is to be transmitted. This information can be at least one of information, data, audio, a video, an image, a command, or other information.

Controller 206 transmits hydroacoustic waves 208 at underwater cable 210 having optical fiber 212 in which light 214 travels using acoustic transmitter 204. Hydroacoustic waves 208 impinges on underwater cable 210 causing localized changes 211 in the underwater cable 210 that changes a state 216 of light 214 traveling in underwater cable 210 that corresponds to information 207 encoded in hydroacoustic waves 208.

In this illustrative example, hydroacoustic waves 208 can be modulated when transmitted by acoustic transmitter 204 to encode information 207. For example, amplitude of hydroacoustic waves 208 can be modulated to encode information 207. In another illustrative example, hydroacoustic waves 208 can be pulsed to encode information 207. For example, the change in amplitude of hydroacoustic waves 208, phase of hydroacoustic waves 208, or some combination thereof can be a symbol such as bits in information 207.

These changes to hydroacoustic waves 208 impinging on underwater cable 210 can cause localized changes 211 that result in state 216 of light 214 changing in a manner that corresponds to these changes in hydroacoustic waves 208 encoding information 207. This correspondence of the changes in state 216 of light 214 to changes in hydroacoustic waves 208 can be used to recover information 207 from light 214 based on the changes in state 216 of light 214.

As depicted, in this example, the changes in state 216 can include at least one of polarization, a phase, a power level change or other types of states for light 214. This phenomenon is a result of the acousto-optic effect, where hydroacoustic waves 208 temporarily deform optical fiber 212, leading to changes in its optical properties. Consequently, light 214 transmitted within optical fiber 212 experiences state changes such as polarity, phase, or intensity variations, which can be detected and decoded to interpret recovered information 207 that was encoded in hydroacoustic waves 208. For example, when optical fiber 102 is vibrated, the asymmetry of the vibration can create asymmetric stress in optical fiber 102, resulting in a polarization dependent effective refractive index in the fiber bends due to the stress-optic effect (i.e., birefringence). In another example, when optical fiber 102 is vibrated, the asymmetry of the vibration can create polarization dependent optical path lengths in the region where optical fiber 102 bends. This bending of optical fiber 102 can change the polarization of light 101 depending on the polarization state of light 101 relative to the polarization dependent optical path lengths. In addition, both the birefringence and optical path length differences described in these two examples can occur simultaneously.

In one illustrative example, controller 206 transmits hydroacoustic waves 208 at angle 226 relative to underwater cable 210 having optical fiber 212 in which light 214 travels using acoustic transmitter 204. With this example, hydroacoustic waves 208 impinge on underwater cable 210 causing localized changes 211 in underwater cable 210 that changes state 216 of light 214 traveling in underwater cable 210 wherein hydroacoustic amplitude extremas 228 for hydroacoustic waves 208 traveling though water matches localized amplitude extremas 229 for localized changes 211 in underwater cable 210 at resonance frequency 238 of underwater cable 210.

In one illustrative example, localized changes 211 are physical waves 270 that take the form of at least one of transverse wave 220 or longitudinal wave 260. Transverse wave 120 in FIG. 1A is an example of transverse wave 220. Longitudinal wave 122 in FIG. 1B is an example of longitudinal wave 260.

In this example, transverse wave 220 can be standing transverse wave 222, traveling transverse wave 224, or a combination of the two. Further, longitudinal wave 260 can be standing transverse wave 262, traveling transverse wave 264, or a combination of the two.

In one illustrative example, controller 206 transmits hydroacoustic waves 208 at angle 226 relative to underwater cable 210 using acoustic transmitter 204. In this example, angle 226 is relative to underwater cable 210. For example, angle 226 for the path along which hydroacoustic waves 208 travel relative to a specific portion of underwater cable 210 that hydroacoustic waves 208 impinges. For example, when hydroacoustic waves 208 travel in a path that is perpendicular to underwater cable 210, angle 226 to that specific portion of underwater cable 210 is 90 degrees.

Angle 226 can be selected such that hydroacoustic amplitude extremas 228 for hydroacoustic waves 208 align with mechanical amplitude extremas 231 for transverse wave 220. In this example, the amplitude extremas are peaks and troughs for the amplitudes of the waves.

In this example, angle 226 can be selected such that hydroacoustic amplitude extremas 228 align with density amplitude extremas 266 for longitudinal wave 260. These density amplitude extremas indicate extreme or peak intensities in longitudinal wave 260.

In another illustrative example, controller 206 transmits a first set of hydroacoustic waves 208 and a second set of hydroacoustic waves 208 at angles relative to underwater cable 210 using acoustic transmitter 204. In this example, the angle of the first set of hydroacoustic waves 208 and the angle for the second set of hydroacoustic waves 208 are such that interference pattern 225 is present and creates standing hydroacoustic waves 230 having hydroacoustic nodes 232 that align with mechanical nodes 234 of standing transverse wave 222. In this illustrative example, hydroacoustic nodes 232 are points or locations in hydroacoustic waves 208 that do not change in amplitude. Similarly, mechanical nodes 234 are points or locations in standing transverse wave 222 that do not change in amplitude.

Further, in one illustrative example, hydroacoustic waves 208 has hydroacoustic frequency 236 that is resonance frequency 238 of underwater cable 210. Efficiency and power transfer of power from hydroacoustic waves 208 to underwater cable 210 can be increased when hydroacoustic frequency 236 is selected to be resonance frequency 238 of underwater cable 210.

In another example, hydroacoustic waves 208 can have a frequency that is lower (i.e., infrasound) or much higher (i.e., ultrasound) than the resonance frequency of underwater cable 210. In this example, the ultrasonic signals are transmitted in a direction that is perpendicular to the underwater cable. For example, angle 226 can be 90 degrees when the frequency of hydroacoustic waves 208 are ultrasonic signals. These frequencies can be, for example, 20 kHz to 15 MHz or higher.

In this illustrative example, receiver 240 has optical connection 242 to an end of optical fiber 212 in underwater cable 210. In this example, receiver 240 is a hardware system that is configured to generate electrical signals in response to detecting light 214 in optical fiber 212. Receiver 240 can include software, hardware, or a combination of the two that operates to identify information 207 using the changes to state 216 of light 214 detected at the end of optical fiber 212.

In this example, receiver 240 can utilize at least one of a polarization monitoring or an interferometry technique to detect changes in state 216 of light 214 traveling in optical fiber 212. For example, polarization monitoring can be performed using optical devices and detectors. The polarizer or a polarization beam can separate incoming light into the different polarization components. These components can be measured using photo detectors in the relative intensities of phases to provide information about the state of polarization. With respect to interferometry, optical interferometry or microwave photonics interferometry can be used to determine changes in phase in state 216 of light 214.

In this example, noise 244 can be present in light 214. Noise 244 can be caused by at least one of an environmental change, light signal transmitting equipment, and light signal receiving equipment.

Filter 246 can be used to filter changes to state 216 of light 214 in a frequency domain to isolate the changes to state 216 of light 214 from noise 244 in light 214. Thus, the receiver 240 in filter 246 can recover information 207 from changes in state 216 of light 214. By filtering state 216 of light 214, the signal-to-noise ratio is increased.

In one illustrative example, one or more technical solutions are present that overcome a problem with transmitting information underwater. As a result, one or more technical solutions may provide a solution in which information can be encoded in hydroacoustic signals. Those hydroacoustic signals can be directed at an underwater cable in which an optical fiber carrying light is present. The hydroacoustic signals cause localized changes to the underwater cable. These localized changes change the properties of the optical fiber resulting in state changes in the light. The occurrence of these changes can correspond to the information encoded in hydroacoustic waves. The state changes can be detected at a receiver that identifies or recovers information encoded in the hydroacoustic waves from the state changes in the light.

The illustration of communications environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, platform 205 is shown as being a separate block from communications system 202. In some illustrative examples, platform 205 can include communications system 202. As another example, one or more acoustic transmitters in addition to acoustic transmitter 204 can be present in communications system 202 to achieve acoustic wave division multiplexing. These acoustic transmitters can also transmit hydroacoustic waves that encode information 207 such that each transmitter uses a unique hydroacoustic frequency and these frequencies are individually separated with a bank of filters at the coherent receiver.

Turning next to FIG. 3, an illustration of a schematic diagram for transmitting information is depicted in accordance with an illustrative embodiment. In this illustrative example, unmanned underwater vehicle (UUV) 300 is an example of platform 205 that can implement communications system 202 in FIG. 2.

As depicted, unmanned underwater vehicle 300 transmits hydroacoustic waves 302 at underwater cable 304, which includes light 306 traveling through an optical fiber (not shown) in underwater cable 304. In this example, localized changes to underwater cable 304 and changes to light are shown over time. In this example, axis 307 represents time.

As depicted, the time when hydroacoustic waves 302 impinge on underwater cable 304 is time t1. Hydroacoustic waves 302 cause deformation that is localized change 310. In this example, localized change 310 is a transverse wave that is present for a period from time t1 to time t2. In this example, the time from time t1 to time t2 is mechanical settling time 314. A lower settling time results in a faster bit rate.

This deformation causes changes to the state of light 306 traveling through the optical fiber in underwater cable 304. As can be seen, portion 312 of light 306 has a state change that is caused by localized change 310 in underwater cable 304. As depicted in this example, portion 312 of light 306 increases until localized change 310 is no longer present as shown in time t3. As depicted, portion 312 of light 306 travels along the optical fiber in underwater cable 304. Other portions of light 306 do not have these state changes because these portions of light did not travel through the optical cable in a section where localized change 310 occurs.

In this illustrative example, the state change is a change in polarization. This state change can be determined using a polarization monitoring technique or algorithm implemented in a receiver or other device that receives light 306. In this example, the change in polarization can be used to identify digital bits 330 from light 306.

As light interacts with materials in the optical fiber in underwater cable 304, deformations such as a transverse wave can cause polarization changes in light 306. These changes to the polarization of light 306 can be shown using Poincare sphere 340 to visualize the polarization of light 306. Poincare sphere 340 is a three-dimensional sphere where any point on the surface of Poincare sphere 340 corresponds to a specific polarization state. This sphere is described using Stokes coordinates S1, S2, and S3. The changes in the visualization of Poincare sphere 340 digital bits 330 in the form of a logic 0 and a logic 1. In this example, digital bits 330 are 010.

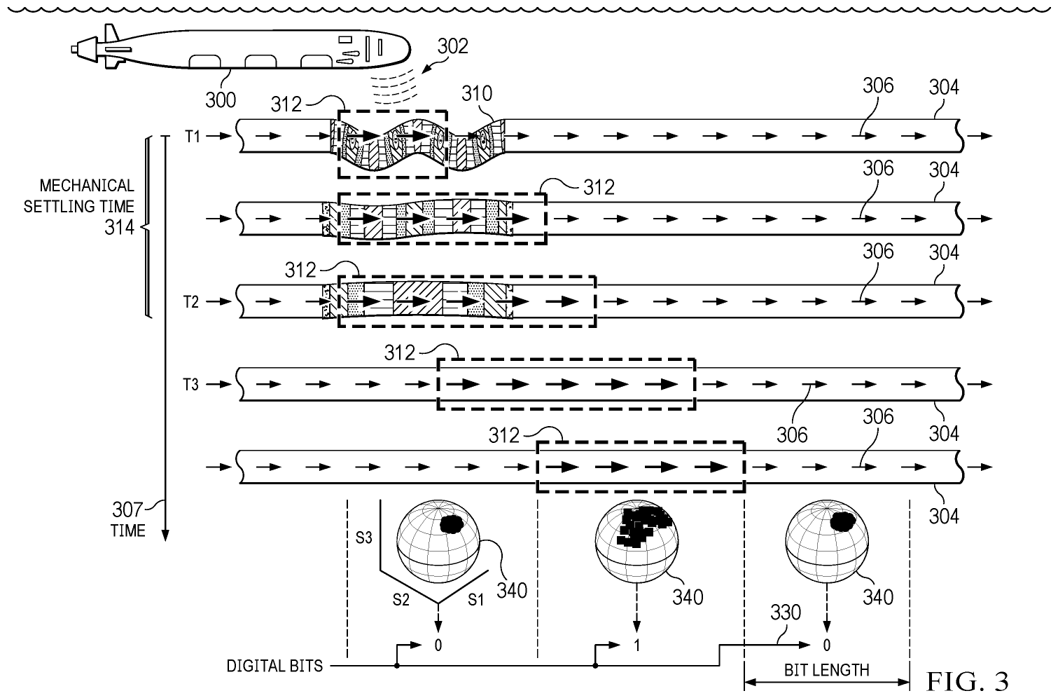

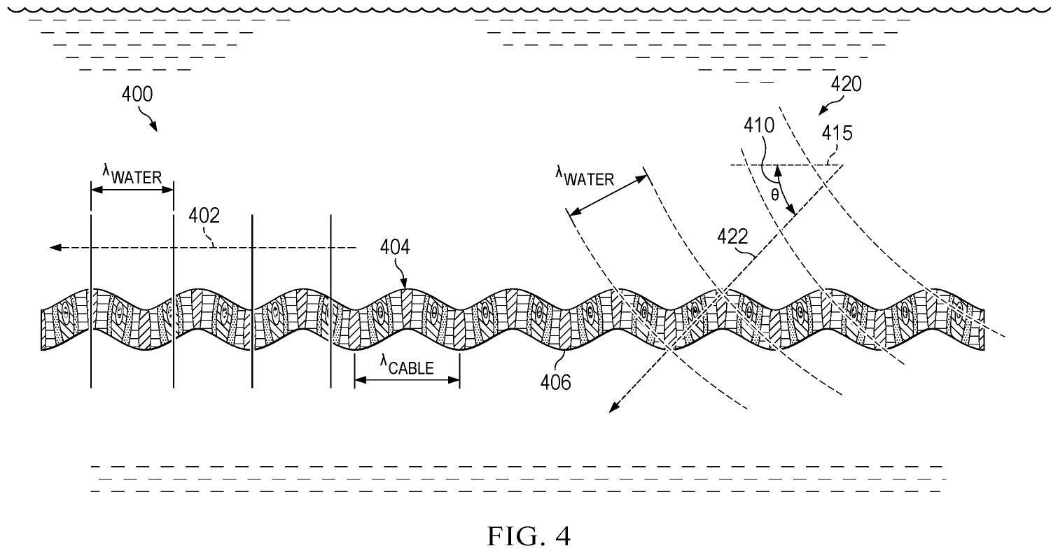

With reference next to FIG. 4, an illustration of transmission angles is depicted in accordance with an illustrative embodiment. In this illustrative example, hydroacoustic waves 400 are transmitted in the direction of arrow 402, which is parallel to underwater cable 404. In this illustrative example, hydroacoustic waves 400 are transmitted using a resonance frequency of underwater cable 404.

Resonance frequencies refer to those specific frequencies at which a system or object naturally oscillates with the greatest amplitude. The fundamental mode is also referred to as a first harmonic mode and has the lowest resonance frequency. Higher order modes have higher resonance frequencies. In this example, underwater cable 404 can have multiple modes with each having a resonance frequency that can be selected for transmitting hydroacoustic waves 400.

Although hydroacoustic waves 400 are transmitted using a resonance frequency for underwater cable 404, hydroacoustic waves 400 travel through water which has different properties from the material forming underwater cable 404.

This difference of properties between water and underwater cable 404 results in a mismatch between wavelengths for the cable and water. In this example, the wavelength can be calculated for hydroacoustic waves 400 as the velocity of hydroacoustic waves 400 divided by the frequency of hydroacoustic waves 400. The determination of the wavelength of underwater cable 404 can be determined in a similar fashion for transverse wave 406 in underwater cable 404.

In this example, the difference between the wavelength of water and the wavelength of underwater cable 404 results in the extremas between the hydroacoustic waves 400 and transverse wave 406 having peaks and troughs that do not align. In other words, the extremas between hydroacoustic waves 400 and transverse wave 406 are not aligned. As a result, the power transfer of energy from hydroacoustic waves 400 to underwater cable 404 is not as efficient as desired with an angle of 0 degrees.

In this example, efficiency in transmitting power from hydroacoustic waves to underwater cable 404 can be increased by selecting angle (θ) 410 for transmitting hydroacoustic waves 420 in the direction of arrow 422. For example, if λ_{water}<λ_{cable}, angle (θ) 410 can be selected as follows: cos(θ)=λ_{water}/λ_{cable} where (θ) is angle (θ) 410, λ_{water} is the wavelength of water, and λ_{cable} is a wavelength of underwater cable 404. If λ_{water}>λ_{cable}, angle (θ) 410 can be selected as follows: cos(θ)=λ_{cable}/λ_{water}.

This transmission of hydroacoustic waves 420 in the direction of arrow 422 results in the peaks and troughs of hydroacoustic waves 420 aligning with the peaks and troughs of transverse wave 406. Angle(θ) 410 is an angle relative to underwater cable 404. In this example, line 415 is parallel to underwater cable 404 and used to measure angle(θ) 410 to transmit hydroacoustic waves 420.

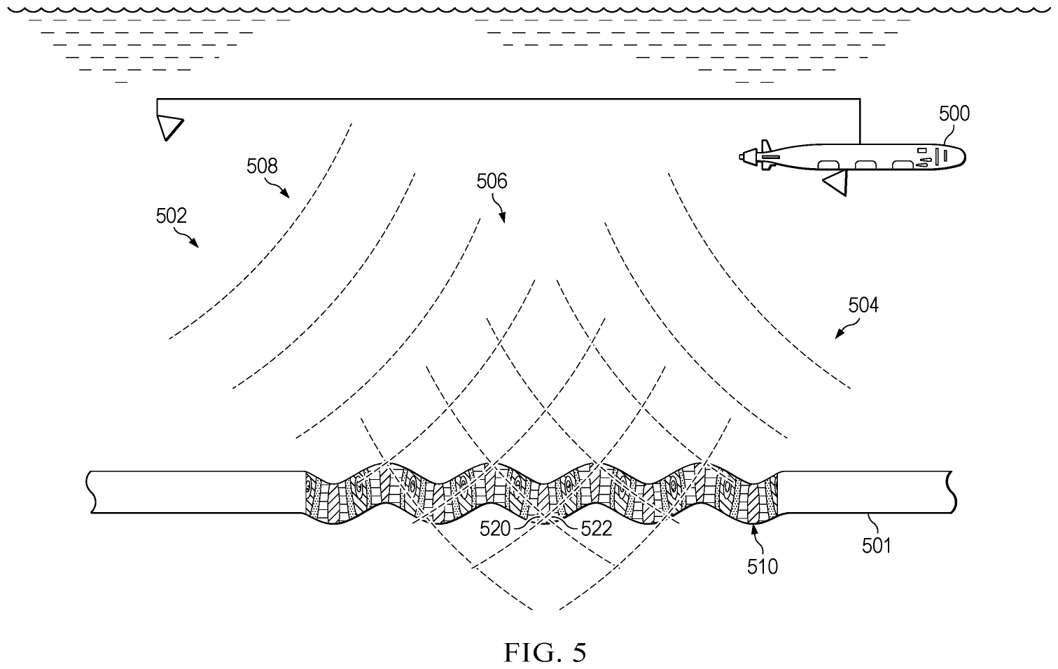

Turning next to FIG. 5, an illustration of a communication system for transmitting information is depicted in accordance with an illustrative embodiment. In this illustrative example, unmanned underwater vehicle (UUV) 500 is an example of platform 205 and can implement communications system 202 in FIG. 2.

In this example, the acoustic transmitter in unmanned underwater vehicle 500 transmits two sets of hydroacoustic waves at underwater cable 501, which has an optical fiber with light traveling through the optical fiber.

As depicted, hydroacoustic waves 502 is a first set of hydroacoustic waves transmitted by unmanned underwater vehicle 500 and hydroacoustic waves 504 is a second set of hydroacoustic waves transmitted by unmanned underwater vehicle 500. In this example, the transmission of hydroacoustic waves 502 and hydroacoustic waves 504 creates interference pattern 506. This interference pattern results in standing hydroacoustic waves 508.

In this example, standing hydroacoustic waves 508 impinge on underwater cable 501 in a manner that creates standing transverse wave 510, which is a stationary wave that does not move along the length of underwater cable 501. In this example, standing hydroacoustic waves 508 have hydroacoustic nodes that align with mechanical nodes of standing transverse wave 510. For example, hydroacoustic node 520 for standing hydroacoustic waves 508 aligns with mechanical node 522 for standing transverse wave 510.

The illustration of the transverse waves in FIGS. 3-4 are provided as one type of physical wave. In other illustrative examples, other types of physical waves, such as a longitudinal wave, can be used in place of or in addition to transverse waves.

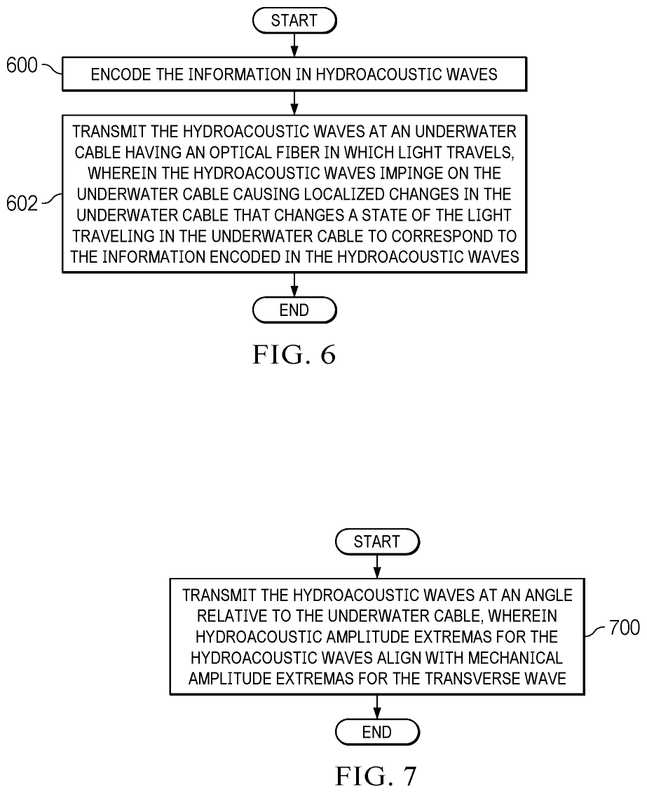

Turning next to FIG. 6, an illustration of a flowchart of a process for transmitting information is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in controller 206 in communications system 202 in FIG. 2.

The process begins by encoding the information in hydroacoustic waves (operation 600). The process transmits the hydroacoustic waves at an underwater cable having an optical fiber in which light travels, wherein the hydroacoustic waves impinge on the underwater cable causing localized changes in the underwater cable that changes a state of the light traveling in the underwater cable to correspond to the information encoded in the hydroacoustic waves (operation 602). The process terminates thereafter.

This correspondence of the change in the state of light to the hydroacoustic waves encoding the information is used to recover the information encoded in the hydroacoustic waves.

With reference to FIG. 7, an illustration of a flowchart of a process for transmitting hydroacoustic waves is depicted in accordance with an illustrative embodiment. The process in this figure is an example of an implementation for operation 602 in FIG. 6.

The process transmits the hydroacoustic waves at an angle relative to the underwater cable, wherein hydroacoustic amplitude extremas for the hydroacoustic waves align with mechanical amplitude extremas for the transverse wave (operation 700). The process terminates thereafter.

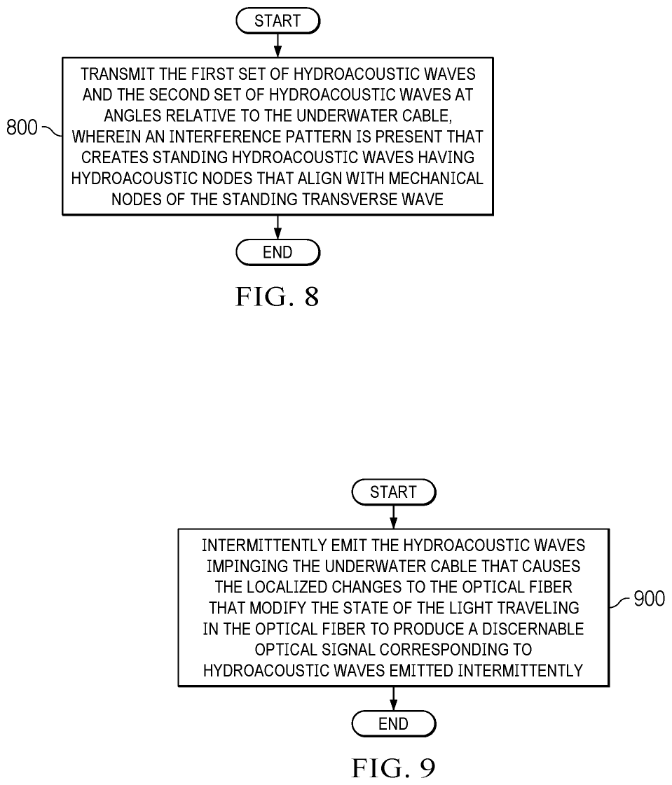

In FIG. 8, an illustration of a flowchart of a process for transmitting hydroacoustic waves is depicted in accordance with an illustrative embodiment. The process in this figure is an example of an implementation for operation 602 in FIG. 6. In this example, the hydroacoustic waves comprise a first set of hydroacoustic waves and a second set of hydroacoustic waves.

The process transmits the first set of hydroacoustic waves and the second set of hydroacoustic waves at angles relative to the underwater cable, wherein an interference pattern is present that creates standing hydroacoustic waves having hydroacoustic nodes that align with mechanical nodes of the standing transverse wave (operation 800). In this example, the nodes are points on the waves where those points do not change in amplitude.

Next with reference to FIG. 9, an illustration of a flowchart of a process for transmitting hydroacoustic waves is depicted in accordance with an illustrative embodiment. The process in this figure is an example of an implementation for operation 602 in FIG. 6.

The process intermittently emits the hydroacoustic waves impinging the underwater cable that causes the localized changes to the optical fiber that modify the state of the light traveling in the optical fiber to produce a discernable optical signal corresponding to hydroacoustic waves emitted intermittently (operation 900). The process terminates thereafter. The light in this discernible optical signal can be processed by a receiver to recover information encoded in the hydroacoustic waves.

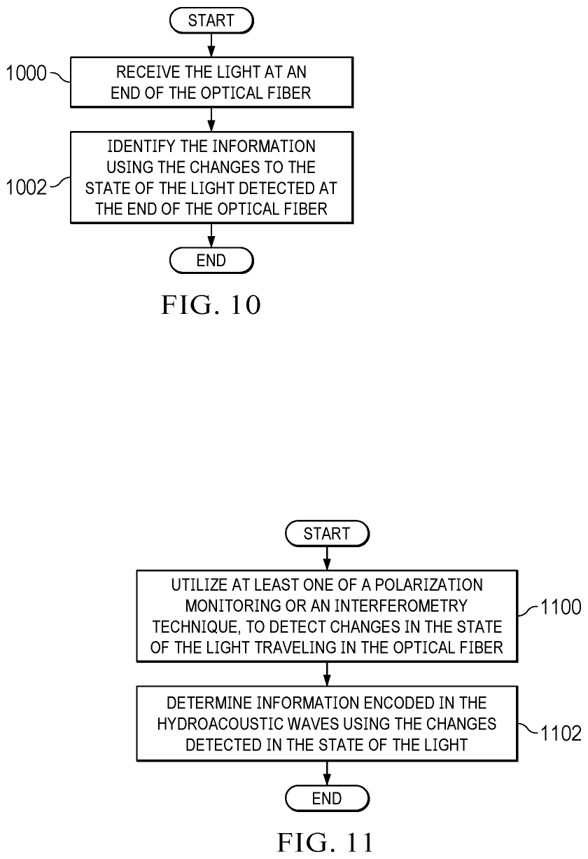

With reference now to FIG. 10, an illustration of a flowchart of a process for recovering information is depicted in accordance with an illustrative embodiment. The process in FIG. 10 can be implemented in hardware, software, or both. When implemented in software, the process can take the form of program instructions that are run by one of more processor units located in one or more hardware devices in one or more computer systems. For example, the process can be implemented in controller 206 in receiver 240 in FIG. 2.

The process receives the light at an end of the optical fiber (operation 1000). The process identifies the information using the changes to the state of the light detected at the end of the optical fiber (operation 1002). The process terminates thereafter.

Turning now to FIG. 11, an illustration a flowchart of a process for recovering information is depicted in accordance with an illustrative embodiment. The process depicted in this flowchart is an example of an implementation for operation 1002 in FIG. 10.

The process utilizes at least one of a polarization monitoring or an interferometry technique, to detect changes in the state of the light traveling in the optical fiber (operation 1100). The process determines information encoded in the hydroacoustic waves using the changes detected in the state of the light (operation 1102). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

For example, operation 800 in FIG. 8 can occur with a standing longitudinal wave in addition to or in place of the standing transverse wave.

Further in these examples, light transmitted through an underwater cable is shown. This light can be a reference signal in these examples. Where hydroacoustic waves that are at the resonance frequency of the underwater cable (i.e., submarine cable) impinges the underwater cable, light that is transmitted through the underwater cable will have an amplitude that corresponds to the hydroacoustic waves at the resonance frequency of the underwater cable. The response to the hydroacoustic waves can be monitored to detect a decrease from the peak response signal corresponding to the hydroacoustic waves at the resonance frequency of the underwater cable, where the decrease from the peak response is indicative of a physical change such as damage, corrosion, stress, strain, temperature change, or other physical changes to a section of the underwater cable. This decrease may be where the response is significantly lower than that of the peak response corresponding to the hydroacoustic waves at the resonance frequency of the underwater cable.

Similarly, the light that is transmitted through a section of the underwater cable with a physical change will experience a change in optical power, polarization, phase, or frequency of the light transmitted through the underwater cable. This means that it is possible to monitor the light that is transmitted though the underwater cable to detect if a section of the underwater cable is damaged or has some other physical change. For example, it is possible to detect a change indicative of the physical change to the underwater cable by monitoring the optical power of the light, or by monitoring the polarization of the light for a change in polarization, or by monitoring the frequency of the light for a shift in frequency, or by monitoring the phase of the light for a phase shift. Accordingly, an example of a system and method for inspecting an underwater cable is provided, where the response for a number of characteristics of the light transmitted through the underwater cable can be monitored to detect a change from the peak response corresponding to the hydroacoustic waves at the resonance frequency of the underwater cable. The system and method for inspecting an underwater cable can also detect where the change in the response occurred in order to detect the section in which physical change to the underwater cable has occurred.

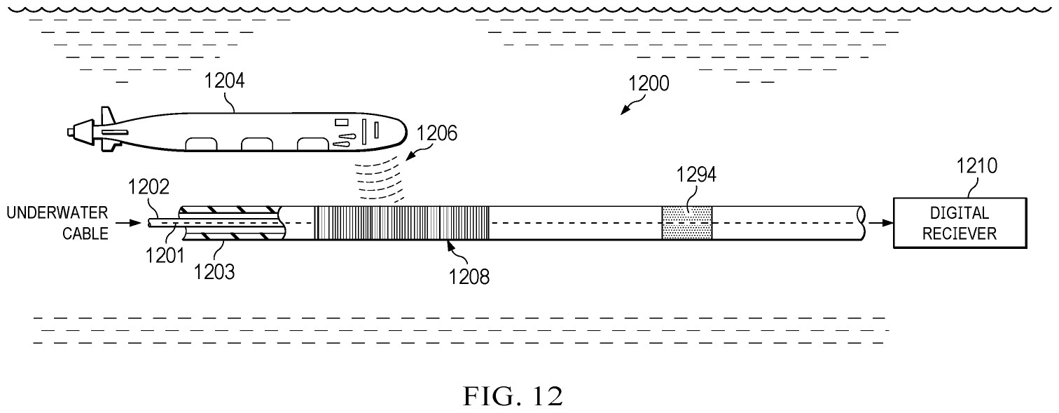

Next, FIG. 12 is an illustration of a schematic diagram of a physical change detection system that detects a physical change to an underwater cable that carries information in an optical fiber in accordance with an illustrative embodiment.

In physical change detection environment 1200, light 1201 travels through optical fiber 1202 in underwater cable 1203. In this example, light 1201 can travel in one or more optical communications channels within optical fiber 1202. This light can be modulated to carry information. A physical change to section 1294 of underwater cable 1203 can cause reduced efficiency in errors and transmitting data using light 1201. In this example, the physical change is a change to underwater cable 1203 that can cause changes in a number of characteristics of light 1201 through underwater cable 1203. The physical change can be selected from at least one of a change in a mechanical property, a change in a shape, a damage, a corrosion, a stress, a strain, a temperature, or other change.

As a result, physical change detection can be performed on underwater cable 1203 using an underwater vehicle such as unmanned underwater vehicle (UUV) 1204. In this example, as depicted, unmanned underwater vehicle (UUV) 1204 can transmit hydroacoustic waves 1206 that impinges on underwater cable 1203. These hydroacoustic waves can be transmitted to perform physical change detection to identify a physical change to a section or sections of underwater cable 1203.

In this example, hydroacoustic waves 1206 impinging on underwater cable 1203 causes localized changes 1208 to occur in underwater cable 1203 including optical fiber 1202.

Localized changes 1208 are short-term changes in these examples. Localized changes 1208 can be a deformation of optical fiber 1202 in that is a response with a frequency. Further, these localized changes of optical fiber 1202 can change the optical properties of optical fiber 1202 at the location of localized changes 1208.

Localized changes 1208 can take a number of different forms. As depicted in this example, localized changes 1208 can be a physical wave in the form of a longitudinal wave. This longitudinal wave can be, for example, one of a moving longitudinal wave or a stationary longitudinal wave.

As a result, localized changes 1208 can change a number of characteristics of light 1201 traveling through optical fiber 1202. This change in the number of characteristics can be at least one of an optical power, a polarization, a phase, a frequency, or some other characteristic of light 101.

In other words, energy in hydroacoustic waves 106 can be imprinted on a characteristic such as a state of polarization (SOP) of light 1201. This polarization change can occur in each of the optical channels that light 1201 travels in optical fiber 1202.

In this illustrative example, these changes to the number of characteristics of light 1201 can be detected by a receiver such as digital receiver 1210. Digital receiver 1210 is a hardware device optically connected to optical fiber 1202. This type of device is an optical device that can detect and decode phase, polarization, frequency, amplitude, and other information from modulated optical signals such as light 101. This device converts light 101 into electrical signals.

With a greater number of optical channels, an increased sensitivity in digital coherent receiver 110 detecting changes in the state of light 101 is present. As a result, information can be transferred at a higher bit rate. Alternatively, in an application where power may be limited, for the same data rate, less power can be used to transmit the hydroacoustic wave. In addition, a combination of higher data rate and lower transmit power can be implemented.

In performing physical change detection, hydroacoustic waves 1206 are transmitted by unmanned underwater vehicle at a hydroacoustic frequency that is a resonance frequency of underwater cable 1203. In this illustrative example, underwater cable 1203 can have different modes of vibration and each one has its own resonance frequency. By using a resonance frequency of underwater cable 1203, the response in the changes in the number of characteristics of light 1201 caused by the longitudinal wave detected by digital receiver 1210 can be a maximum or peak change as compared to when other frequencies other than the resonance frequency is used to transmit hydroacoustic waves 1206.

The number of characteristics 1316 can take a number of different forms. For example, the number of characteristics 1316 can be selected from at least one of an optical power, a polarization, a phase, a frequency, or some other characteristic of light 1314.

The illustration of localized changes 1208 in the form of a longitudinal wave is intended as an example and not meant to limit the manner in which other illustrative examples can be implemented. In another example, localized changes 1208 can be a transverse wave instead of a longitudinal wave. In another example, the underwater vehicle can be a manned underwater vehicle.

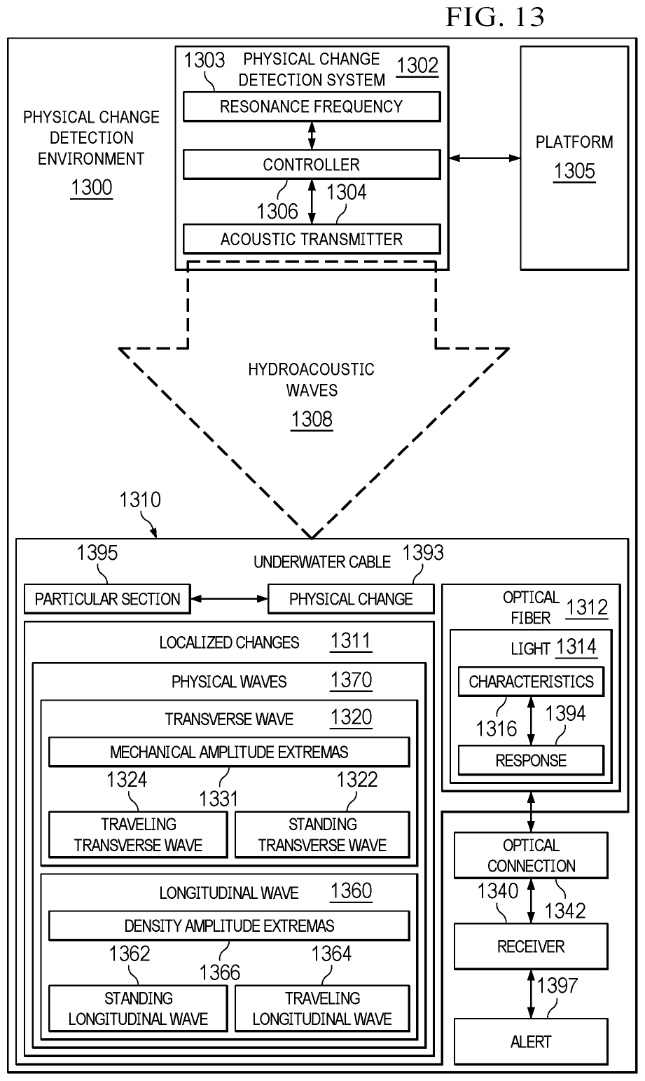

With reference now to FIG. 13, an illustration of a block diagram of a physical change detection environment is depicted in accordance with an illustrative embodiment. In this example, physical change detection environment 1200 in FIG. 12 is an example of an implementation for physical change detection environment 1300 in FIG. 13.

Physical change detection system 1302 can be implemented in platform 1305. In this example, platform 1305 can be selected from at least one of a stationary platform, a mobile platform, an aquatic-based structure, unmanned underwater vehicle, a submarine, an underwater habitat, an underwater sensor station, an undersea lab, a surface ship, or other suitable platform.

In this example, physical change detection system 1302 includes a number of different components that can be used to transmit information. As depicted, physical change detection system 1302 comprises acoustic transmitter 1304 and controller 1306.

In this example, acoustic transmitter 1304 is a hardware system that can also include software and is connected to platform 1305. Acoustic transmitter 1304 is connected to platform 1305 and is configured to transmit hydroacoustic waves 1308.

When one component is “connected” to another component, the connection is a physical connection in these examples. For example, a first component, acoustic transmitter 1304, can be considered to be physically connected to a second component, platform 1305 by at least one of being secured to the second component, bonded to the second component, mounted to the second component, welded to the second component, fastened to the second component, or connected to the second component in some other suitable manner. The first component also can be connected to the second component using a third component. The first component can also be considered to be physically connected to the second component by being formed as part of the second component, an extension of the second component, or both. In some examples, the first component can be physically connected to the second component by being located within the second component.

The operation of acoustic transmitter 1304 is controlled by controller 1306. Controller 1306 can be implemented in software, hardware, firmware, or a combination thereof. When software is used, the operations performed by controller 1306 can be implemented in program instructions configured to run on hardware, such as a processor unit. When firmware is used, the operations performed by controller 1306 can be implemented in program instructions and data stored in persistent memory to run on a processor unit. When hardware is employed, the hardware can include circuits that operate to perform the operations in controller 206.

In the illustrative examples, the hardware can take a form selected from at least one of a circuit system, an integrated circuit, an application specific integrated circuit (ASIC), a programmable logic device, a processor unit. When controller 1306 is a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices.

When controller 1306 includes a number of processor units, the number of processor units can be selected from at least one of a single core processor, a dual-core processor, a multi-processor core, a general- purpose central processing unit (CPU), a graphics processing unit (GPU), a digital signal processor (DSP), or some other suitable type of hardware configured to perform a number of operations.

Additionally, the processes can be implemented in organic components integrated with inorganic components and can be comprised entirely of organic components excluding a human being. For example, the processes can be implemented as circuits in organic semiconductors.

In one illustrative example, controller 1306 is capable of executing program instructions implementing processes in the illustrative examples. In other words, the program instructions can be computer-readable program instructions.

In this illustrative example, controller 1306 controls the operation of acoustic transmitter 1304. In one illustrative example, controller 1306 identifies resonance frequency 1303 of underwater cable 1310 for which physical change detection is to be performed.

Controller 1306 transmits hydroacoustic waves 1308 at underwater cable 1310 having optical fiber 1312 in which light 1314 travels using acoustic transmitter 1304. Hydroacoustic waves 1308 impinges on underwater cable 1310 causing localized changes 1311 in the underwater cable 1310 that changes a number of characteristics 1316 of light 1314 traveling in underwater cable 1310 caused by hydroacoustic waves 1308.

These localized changes can be physical waves 1370. These physical waves can, for example, transverse wave 1320 and longitudinal wave 1360.

In this illustrative example, transverse wave

1320 can be one of traveling transverse wave 1324 and standing transverse wave 1322. Transverse wave 1320 can have mechanical amplitude extremas 1331. Longitudinal wave 1360 can be one of traveling longitudinal wave 1364 and standing longitudinal wave 1362. Longitudinal wave 1360 can have density amplitude extremas 1366.

In this example, hydroacoustic waves 1308 cause response 1394 of a number of characteristics 1316 of light 1314 traveling through optical fiber 1312 in underwater cable 1310 In this example, response 1394 of a number of characteristics 1316 of light 1314 traveling through optical fiber 1312 in underwater cable 1310 in particular section 1395 of underwater cable 1310 changes in response to particular section 1395 having physical change 1393 that results in a different resonance frequency from other sections of underwater cable 1310 without physical change 1393.

Physical change 1393 changes to different components in underwater cable 1310.

In this illustrative example, receiver 1340 has optical connection 1342 to an end of optical fiber 1312 in underwater cable 1310. In this example, receiver 1340 is a hardware system that is configured to generate electrical signals in response to detecting light 1314 in optical fiber 1312. Receiver 1340 can include software, hardware, or a combination of the two that operates to detect response 1394 of the number of characteristics 1316 of light 1314 detected at the end of optical fiber 1312.

In this example, receiver 1340 can utilize at least one of a polarization monitoring or an interferometry technique to detect response 1394 for the number of characteristics 1316 of light 1314 traveling in optical fiber 1312.

For example, polarization monitoring can be performed using optical devices and detectors. The polarizer or a polarization beam can separate incoming light into the different polarization components. These components can be measured using photo detectors in the relative intensities of phases to provide information about the state of polarization. With respect to interferometry, optical interferometry or microwave photonics interferometry can be used to determine changes in phase to detect response 1394 of a characteristic in the number of characteristics 1316 of light 1314.

Additionally, receiver 1340 can generate alert 1397 in response to response 1394 indicating physical change 1393 in particular section 1395. In this example, response 1394 of characteristics 1316 can be analyzed to determine whether this response varies from the expected response when physical change 1393 is not present. Whether response 1394 is within a desired range can be determined in a number of different ways. For example, data can be collected for light 1314 transmitted through underwater cable 1310 when underwater cable 1310 is known to not have physical change 1393. Data can include measuring response 1394 for any number of characteristics 1316. These measurements form a baseline from which comparisons can be made to determine whether physical change 1393 has occurred in one or more sections of underwater cable 1310.

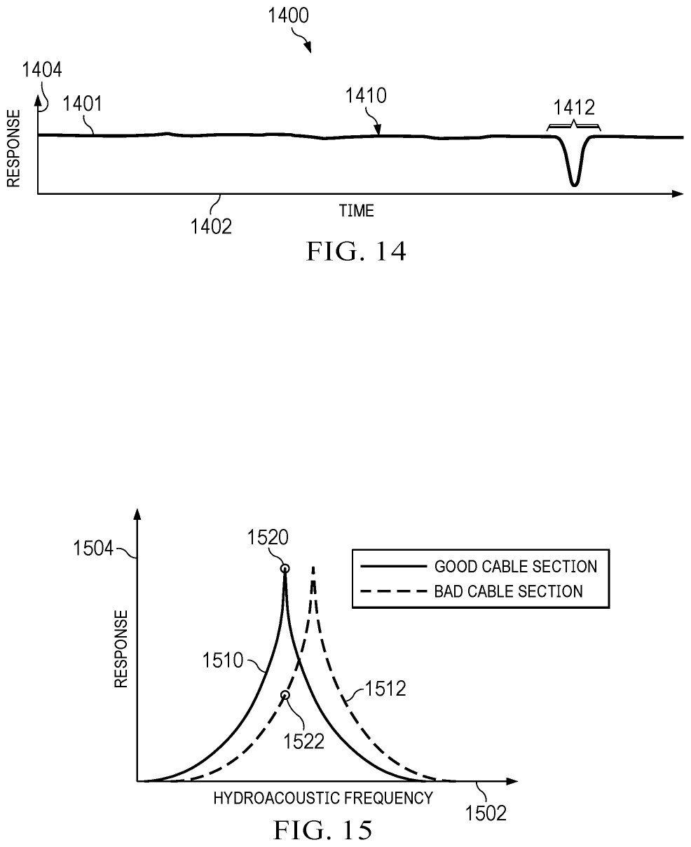

Turning next to FIG. 14, an illustration of a response graph for an underwater cable is depicted in accordance with an illustrative embodiment. In this example, line 1401 in graph 1400 is a response of characteristics such as polarization for light traveling through an underwater cable such as underwater cable 1203 in FIG. 12 and underwater cable 1310 in FIG. 13.

As depicted, x axis 1402 is time and y-axis 1404 is the response of the polarization of the light. This response is generated by hydroacoustic waves from an underwater vehicle moving along the underwater cable to scan the underwater cable using the hydroacoustic waves. The hydroacoustic waves are at the resonance frequency of the cable. The response should be a maximum peak response for polarization changes for portions of the cable that do not have physical changes. Thus, hydroacoustic waves can be transmitted by the acoustic transmitter using spatial scanning to scan sections of the underwater cable as the underwater vehicle moves. In another example, the hydroacoustic waves are transmitted by the acoustic transmitter that is stationary such that aging of the underwater cable can be monitored over time.

As depicted, line 1401 shows a peak response over time at most points such as point 1410. Section 1412 of line 1401 shows that a physical change has occurred resulting in a drop in the response of line 1401 and section 1412. This physical change can be an area of damage in the cable. This area of damage can occur from insulation defects, extensive voids, water treeing, mechanical stress, partial discharges, overheating, electric, local erosion, and other changes.

With reference next to FIG. 15, an illustration of a graph of a resonant frequency for a cable is depicted in accordance with an illustrative embodiment. In this example, a graph illustrating the response indicating the location of resonance frequencies for a cable having a good section and bad section. In this example, x-axis 1502 is the hydroacoustic frequency and y-axis 1504 is the response of a characteristic of light such as polarization.

In this illustrative example, line 1510 illustrates the response of a good section without physical change, and line 1512 illustrates a response of a bad section that has a physical change.

As can be seen, transmitting hydroacoustic waves with a resonance frequency of the cable results in a peak response at point 1520 for a good cable section. When a bad cable section is reached, the response drops to point 1522 in this example. As can be seen, the bad cable section has a different resonance frequency from the good cable section.

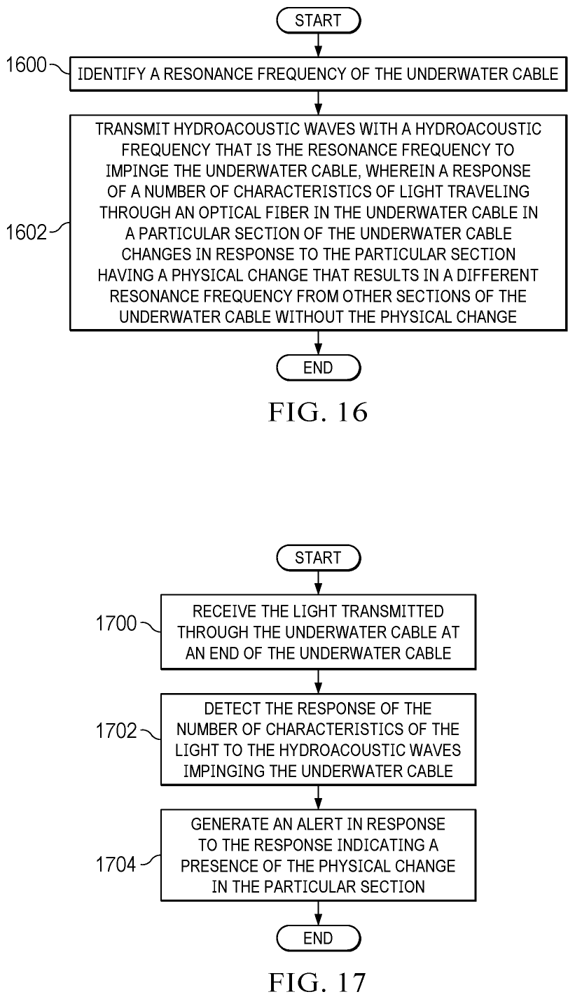

Turning next to FIG. 16, an illustration of a flowchart of a process for predicting a physical change in an underwater cable is depicted in accordance with an illustrative embodiment. The process in FIG. 16 can be implemented in hardware, software, or both. When implemented in software, the process can take the form of program instructions that are run by one of more processor units located in one or more hardware devices in one or more computer systems. For example, the process can be implemented in controller 1306 in physical change detection system 1302 in FIG. 13.

The process begins by identifying a resonance frequency of the underwater cable (operation 1600). The process transmits hydroacoustic waves with a hydroacoustic frequency that is the resonance frequency to impinge the underwater cable, wherein a response of a number of characteristics of light traveling through an optical fiber in the underwater cable in a particular section of the underwater cable changes in response to the particular section having a physical change that results in a different resonance frequency from other sections of the underwater cable without the physical change (operation 1602). The process terminates thereafter.

With reference to FIG. 17, a flowchart of a process for detecting a response to hydroacoustic waves impinging upon an underwater cable is depicted in accordance with an illustrative embodiment. The operations in this flowchart are examples of additional operations that conform with the process in FIG. 16. The process in this figure can be implemented in receiver 1340 in FIG. 13.

The process begins by receiving the light transmitted through the underwater cable at an end of the underwater cable (operation 1700). The process detects the response of the number of characteristics of the light to the hydroacoustic waves impinging the underwater cable (operation 1702).

The process generates an alert in response to the response indicating a presence of the physical change in the particular section (operation 1704). The process terminates thereafter. Thus, hydroacoustic waves can be used to detect physical changes to an underwater table in addition to using these waves to transmit information.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A communications system comprising:
an acoustic transmitter configured to transmit hydroacoustic waves; and
a controller configured to transmit the hydroacoustic waves at an underwater cable having an optical fiber in which light travels using the acoustic transmitter, wherein the hydroacoustic waves impinge on the underwater cable causing localized changes in the underwater cable that changes a state of the light traveling in the underwater cable to correspond to information encoded in the hydroacoustic waves.

2. The communications system of claim 1, wherein the localized changes are one of a transverse wave and a longitudinal wave.

3. The communications system of claim 2, wherein in transmitting the hydroacoustic waves, the controller is configured to:
transmit the hydroacoustic waves at an angle relative to the underwater cable using the acoustic transmitter, wherein hydroacoustic amplitude extremas for the hydroacoustic waves align with mechanical amplitude extremas for the transverse wave.

4. The communications system of claim 2, wherein the transverse wave is a standing transverse wave.

5. The communications system of claim 4, wherein the hydroacoustic waves comprises a first set of hydroacoustic waves and a second set of hydroacoustic waves and wherein in transmitting the hydroacoustic waves, the controller is configured to:
transmit the first set of hydroacoustic waves and the second set of hydroacoustic waves at angles relative to the underwater cable using the acoustic transmitter, wherein an inference pattern is present that creates standing hydroacoustic waves having hydroacoustic nodes that align with mechanical nodes of the standing transverse wave.

6. The communications system of claim 1, wherein the hydroacoustic waves have a hydroacoustic frequency that is a resonance frequency of the underwater cable.

7. The communications system of claim 1, wherein the hydroacoustic waves are ultrasonic signals.

8. The communications system of claim 7, wherein the ultrasonic signals are transmitted in a direction that is perpendicular to the underwater cable.

9. The communications system of claim 1, wherein in controlling the acoustic transmitter to transmit the hydroacoustic waves, the controller is configured to:
transmit the hydroacoustic waves at an angle relative to the underwater cable having the optical fiber in which the light travels using the acoustic transmitter, wherein the hydroacoustic waves impinge on the underwater cable causing the localized changes in the underwater cable that changes the state of the light traveling in the underwater cable wherein hydroacoustic amplitude extremas for the hydroacoustic waves traveling though water matches localized amplitude extremas for the localized changes in the underwater cable at a resonance frequency of the underwater cable.

10. The communications system of claim 1 further comprising:
a receiver with an optical connection to an end of the optical fiber in the underwater cable, wherein the receiver is configured to:
identify the information using the changes to the state of the light detected at the end of the optical fiber.

11. The communications system of claim 10 further comprising:
a filter configured to filter changes to the state of the light in a frequency domain to isolate the changes to the state of the light from noise in the light.

12. The communications system of claim 11, wherein the noise is caused by at least one of an environmental change, light signal transmitting equipment, or light signal receiving equipment.

13. The communications system of claim 10, wherein the state is selected from at least one of a polarization, a phase, or a power level change for the light.

14. The communications system of claim 1 further comprising:
a platform, wherein the acoustic transmitter is connected to the platform.

15. The communications system of claim 14, wherein the platform is selected from at least one of a stationary platform, a mobile platform, an aquatic-based structure, unmanned underwater vehicle, a submarine, an underwater habitat, an underwater sensor station, an undersea lab, and a surface ship.

16. The communications system of claim 1, wherein the information comprises at least one of information, data, audio, a video, an image, or a command.

17. A communication system for an underwater vehicle utilizing an underwater cable having an optical fiber in which light travel, the communication system comprising:
an acoustic transmitter configured to emit hydroacoustic waves having a frequency corresponding to a resonance frequency of the underwater cable having the optical fiber to optimize transfer of the hydroacoustic waves impinging the underwater cable that causes changes to the optical fiber that modify the light traveling in the optical fiber, wherein the acoustic transmitter is configured to transmit the hydroacoustic waves through water at an angle relative to the underwater cable such that first extremas the hydroacoustic waves matches second extremas in the changes of the underwater cable at its resonance frequency.

18. The communication system of claim 17 further comprising:
a receiver coupled to the optical fiber in the underwater cable, wherein the receiver is configured to:
utilize at least one of a polarization monitoring or an interferometry technique to detect changes in a state of the light traveling in the optical fiber;
identify information encoded in the hydroacoustic waves using the changes detected in the state of the light.

19. The communication system of claim 17, wherein the acoustic transmitter is configured to:
intermittently emit hydroacoustic waves impinging the underwater cable that causes localized changes to the optical fiber that modifies a state of the light traveling in the optical fiber to produce a discernable optical signal corresponding to the hydroacoustic waves emitted intermittently.

20. A method for transmitting information, the method comprising:
encoding the information in hydroacoustic waves; and
transmitting the hydroacoustic waves at an underwater cable having an optical fiber in which light travels, wherein the hydroacoustic waves impinge on the underwater cable causing localized changes in the underwater cable that changes a state of the light traveling in the underwater cable to correspond to information encoded in the hydroacoustic waves.

21. The method of claim 20, wherein transmitting the hydroacoustic waves comprises:
transmitting the hydroacoustic waves at an angle relative to the underwater cable, wherein hydroacoustic amplitude extremas for the hydroacoustic waves align with mechanical amplitude extremas for a transverse wave.

22. The method of claim 21, wherein the hydroacoustic waves comprises a first set of hydroacoustic waves and a second set of hydroacoustic waves and wherein transmitting the hydroacoustic waves comprises:
transmitting the first set of hydroacoustic waves and the second set of hydroacoustic waves at angles relative to the underwater cable, wherein an inference pattern is present that creates standing hydroacoustic waves having hydroacoustic nodes that align with mechanical nodes of the standing transverse wave.

23. The method of claim 20, wherein transmitting the hydroacoustic waves comprises:
intermittently emitting the hydroacoustic waves impinging the underwater cable that causes the localized changes to the optical fiber that modify the state of the light traveling in the optical fiber to produce a discernable optical signal corresponding to hydroacoustic waves emitted intermittently.

24. The method of claim 20 further comprising:
receiving the light with at an end of the optical fiber; and
identifying the information using the changes to the state of the light detected at the end of the optical fiber.

25. The method of claim 24, wherein identifying the information comprises:
utilizing at least one of a polarization monitoring or an interferometry technique, to detect changes in the state of the light traveling in the optical fiber; and
identifying the information encoded in the hydroacoustic waves using the changes detected in the state of the light.

26. The method of claim 20, wherein the hydroacoustic waves have a hydroacoustic frequency that is a resonance frequency of the underwater cable.

27. A physical change detection system comprising:
an acoustic transmitter configured to transmit hydroacoustic waves; and
a controller configured to:
identify a resonant frequency of an underwater cable; and
transmit hydroacoustic waves with a hydroacoustic frequency that is the resonant frequency to impinge the underwater cable, wherein a response of a number of characteristics of light traveling through an optical fiber in the underwater cable in a particular section of the underwater cable changes in response to the particular section having a physical change that results in a different resonant frequency from other sections of the underwater cable without the physical change.

28. The physical change detection system of claim 27, wherein the hydroacoustic waves cause localized changes in the underwater cable in a form of a transverse wave.

29. The physical change detection system of claim 28, wherein transverse wave is selected from a group comprising a traveling transverse wave and a standing transverse wave.

30. The physical change detection system of claim 27, wherein the hydroacoustic waves cause localized changes in the underwater cable in a form of a longitudinal wave.

31. The physical change detection system of claim 30, wherein longitudinal wave is selected from a group comprising a traveling longitudinal wave and a standing longitudinal wave.

32. The physical change detection system of claim 27, wherein the number of characteristics is selected from at least one of an optical power, a polarization, a phase or a frequency.

33. The physical change detection system of claim 27, wherein the physical change in the underwater cable is selected from at least one of a change in a mechanical property, a change in a shape, a damage, a corrosion, a stress, a strain, or a temperature.

34. The physical change detection system of claim 1 further comprising:
an underwater vehicle, wherein the acoustic transmitter is connected to the underwater vehicle.

35. The physical change detection system of claim 34, wherein the hydroacoustic waves are transmitted by the acoustic transmitter using spatial scanning to scan sections of the underwater cable as the underwater vehicle moves.

36. The physical change detection system of claim 27, wherein the hydroacoustic waves are transmitted by the acoustic transmitter that is stationary such that aging of the underwater cable can be monitored over time.

37. The physical change detection system of claim 27 further comprising:
a receiver with an optical connection to an end of the optical fiber in the underwater cable, wherein the receiver is configured to:
detect the response of the number of characteristics of the light to the hydroacoustic waves impinging the underwater cable;
indicates detecting a change in the response that is greater than expected for transmitting the hydroacoustic waves at the resonant frequency of the underwater cable at the particular section of the underwater cable that has the physical change.

38. The physical change detection system of claim 27, wherein the hydroacoustic waves are ultrasonic signals.

39. A method for detecting a physical change to an underwater cable, the method comprising:
identifying a resonant frequency of the underwater cable; and
transmitting hydroacoustic waves with a hydroacoustic frequency that is the resonant frequency to impinge the underwater cable, wherein a response of a number of characteristics of light traveling through an optical fiber in the underwater cable in a particular section of the underwater cable changes in response to the particular section having a physical change that results in a different resonant frequency from other sections of the underwater cable without the physical change.

40. The method of claim 39 further comprising:
receiving the light transmitted through the underwater cable at an end of the underwater cable;
detecting the response of the number of characteristics of the light to the hydroacoustic waves impinging the underwater cable; and
generating an alert in response to the response indicating a presence of the physical change in the particular section.

41. The method of claim 39, wherein the hydroacoustic waves cause localized changes in the underwater cable in a form of a transverse wave.

42. The method of claim 41, wherein transverse wave is selected from a group comprising a traveling transverse wave and a standing transverse wave.

43. The method of claim 39, wherein the hydroacoustic waves cause localized changes in the underwater cable in a form of a longitudinal wave.

44. The method of claim 43, wherein longitudinal wave is selected from a group comprising a traveling longitudinal wave and a standing longitudinal wave.

45. The method of claim 39, wherein the number of characteristics is selected from at least one of an optical power, a polarization, a phase or a frequency.

46. The method of claim 39, wherein the physical change in the underwater cable is selected from at least one of a change in a mechanical property, a change in a shape, a damage, a corrosion, a stress, a strain, or a temperature.
